(19) United States
(12) Patent Application Publication
(10) Pub. No.: US 2008/0239484 A1
(43) Pub. Date: Oct. 2, 2008

(54) POLARIZED LIGHT TRANSMISSION SCREEN AND STEREOSCOPIC IMAGE DISPLAYING APPARATUS USING THE POLARIZED LIGHT TRANSMISSION SCREEN

(75) Inventors: Kei Fukaishi, Joetsu-shi (JP); Hiroshi Maruyama, Tokyo (JP); Kazuhiro Ura, Joetsu-shi (JP); Yuuichi Kakubari, Joetsu-shi (JP); Yoshihiro Yoshihara, Joetsu-shi (JP)

Correspondence Address: OSHA LIANG L.L.P., 1221 MCKINNEY STREET, SUITE 2800, HOUSTON, TX, 77010, US

(73) Assignee: ARISAWA MFG. CO., LTD., Joetsu-shi (JP)

(21) Appl. No.: 12/133,170

(22) Filed: Jun. 4, 2008

Related U.S. Application Data
(62) Division of application No. 11/045,745, filed on Jan. 28, 2005.

(30) Foreign Application Priority Data
Jan. 29, 2004 (JP) JP2004-021914

(51) Int. Cl. G02B 27/26

(52) U.S. Cl. 359/465

(57) ABSTRACT

A polarized light transmission screen and a stereoscopic image displaying apparatus capable to display a clear stereoscopic image with few little cross talks over a wide wavelength range. In a polarized light transmission screen 30, a 90-degree rotation regions 32b include in piles a plurality of retarders of which the directions of the optical axes differ with one another, and when the linearly polarized light having a polarization axis of a specific direction is made to be transmitted, they rotates the polarization axis by 90 degrees in total by each of the plurality of retarders rotating the polarization axis less than 90 degrees in steps. A 0-degree rotation regions 32a include in piles a plurality of retarders of which the directions of the optical axes differ with one another, and when the linearly polarized light having a polarization axis of a specific direction is made to be transmitted, the polarization axes of incidence and emission are the same direction.

This patent application claims priority from a Japanese Patent Application No. 2004-021914 filed on Jan. 29, 2004, the contents of which are incorporated herein by reference.

### BACKGROUND OF THE INVENTION

1. Field of the Invention

The present invention relates to a polarized light transmission screen used for display of a stereoscopic image, a stereoscopic image displaying apparatus using the polarized light transmission screen.

2. Description of the Related Art

Conventionally, there have been made various proposals of a system which separately presents two images with parallax to right and left eyes, respectively, as a displaying apparatus which displays a stereoscopic image using a two-dimensional display. For example, a glasses system which separates the light for the left eye and the light for the right eye, of which polarization axes are orthogonal which consist of polarizers (cf. Japanese Patent Laid-Open No. 3-134648), and a glassless system which projects the light which is transmitted through an image for right eye on an observer's right eye, and the light which is transmitted through an image for left eye on the observer's left eye, in which light source of a back light is separated into the image for left eye and the image for right eye (cf. WO01/59508) are known.

As for the glasses system, when separating the light for the left eye and the light for the right eye, one of the linear polarized lights of the left eye and the right eye, which are transmitted through the display device and have polarization axes in the same direction, is transmitted through a half-wave retarder and rotated its axis to be perpendicular to the other. Then, as for the polarized glasses for an observer, directions of the polarization axes of the polarizers for the right eye and the left eye are aligned parallel to the directions of linearly polarized lights of right and left, respectively. Thereby, only the linearly polarized light of the image for the left eye reaches the observer is left eye, and only the linearly polarized light of the image for the right eye reaches the right eye.

On the other hand, as for the glassless system, the linearly polarized lights which are perpendicular with each other is used for a light source for the right eye and a light source for the left eye as the back light. Then, the linearly polarized light for the left eye and the linearly polarized light for the right eye are made to be parallel to the polarization axis of a polarizer by rotating the direction of polarization axis of either of the linearly polarized light for the left eye directing to image display regions for the left eye of the display device or the linearly polarized light for the right eye directing to image display regions for the right eye by 90 degrees by a half-wave retarder. Consequently, only the linearly polarized light for the left eye directing to the image display regions for the left eye and the linearly polarized light for the right eye directing to the display regions for the right eye are incident to the display device. Thus, only the linearly polarized light of the image for the left eye reaches the observer's left eye, and only the linearly polarized light of the image for the right eye reaches the right eye.

However, regardless of whether the glasses system or the glassless system is to be employed, when making the half-wave retarder transmit the linearly polarized light and rotating it by 90 degrees, the direction of the linearly polarized light is differed in the influence of a wavelength dispersion property. Therefore, over wide wavelength range, the polarizer could not fully separate the linearly polarized light for the left eye and linearly polarized light for the right eye, and there has been a problem that cross talk will occur in the stereoscopic image.

In order to solve the foregoing problems, according to a first aspect of the present invention, there is provided a polarized light transmission screen capable to rotate a polarization axis of a linearly polarized light. The polarized light transmission screen includes: a 90-degree rotation region including in piles a plurality of retarders of which directions of optical axes differ from one another, wherein each of the plurality of retarders rotates the polarization axis less than 90 degrees in steps so that the 90-degree rotation region rotates the polarization axis by 90 degrees in total by transmitting a linearly polarized light having a polarization axis of a specific direction; and a 0-degree rotation region including in piles a plurality of retarders of which directions of optical axes differ from one another, wherein each of the plurality of retarders rotates the polarization axis to the both positive and negative directions by the same degree of angle so that the 0-degree rotation region emits a linearly polarized light having a polarization axis of the same direction in which the linearly polarized light enters into the 0-degree rotation region.

In the above-mentioned polarized light transmission screen, the polarization axis is rotated by 90 degrees by the 90-degree rotation regions, of which wavelength dispersion property is lower than only one layer of retarder. Simultaneously, since the 0-degree rotation region rotates the polarization axes to opposite directions to each other by same degrees of angle, it may cancel the wavelength dispersion property. That is, the wavelength dispersion property can be reduced and the polarization axes of the linearly polarized lights transmitted through the 90-degree rotation regions and the 0-degree rotation regions can be made to be perpendicular to each other with sufficient accuracy.

At least one of the plurality of retarders of the 90-degree rotation region and the 0-degree rotation region may be unpatterned retarder. Thus, since it is not necessary to align the uniform retarder to another retarder, it can reduce the variation in the optical property of the polarized light transmission screen caused by assembly error of the plurality of retarders.

According to a second aspect of the present invention, there is provided a polarized light transmission screen capable to rotate a polarization axis of a linearly polarized light. The polarized light transmission screen includes: a patterned retarder including first rotation regions which rotate a linearly polarized light having a polarization axis of a specific direction by +45 degrees and second rotation regions which rotate the linearly polarized light by −45 degrees, which are aligned alternately along a vertical direction; and a uniform retarder which rotates each of the axis of the linearly polarized light rotated by the first rotation regions and the linearly polarized light rotated by the second rotation regions by −45 degrees, wherein retardation property of the uniform retarder in the vertical direction is uniform.

In the above-mentioned polarized-light transmission screen, since the polarized lights which are transmitted through the first rotation regions and the uniform retarder are rotated to opposite directions by the same degree with each other, the wavelength dispersion property is cancelled. Moreover, the linearly polarized light which passes the second rotation regions and the uniform retarder is rotated by 45 degrees, or less than 90 degrees two or more times to the extent of 90 degrees. Thereby, a wavelength dispersion property is reduced rather than a case of rotating it by 90 degrees at once. Moreover, since the retardation property of the uniform retarder relates in the vertical direction is uniform, it is not necessary to align the uniform retarder to each region of the patterned retarder.

Therefore, without being influenced by the assembly error of the patterned retarder and the unpatterned retarder, the polarization axis of the linearly polarized light which is transmitted through the first rotation region may be perpendicular to the polarization axis of the linearly polarized which is transmitted through the second rotation region, over a wide wavelength range, and with sufficient accuracy. Since the three dimensional display apparatus which includes such a polarized light transmission screen can separate an image for a left eye, and an image for a right eye with high precision using the polarizer, it can display a clear stereoscopic image with little cross talk.

According to a third aspect of the present invention, there is provided a polarized light transmission screen capable to rotate a polarization axis of a linearly polarized light.

The polarized light transmission screen includes: a patterned retarder including first rotation regions which rotate a polarization axis of a linearly polarized light, having a specific direction, by −45 degrees and second rotation regions which rotate the linearly polarized light by +45 degrees, which are aligned alternately along a vertical direction; and a uniform retarder which rotates each of the axis of the linearly polarized light rotated by the first rotation regions and the linearly polarized light rotated by the second rotation regions by +45 degrees, wherein retardation property (optical axis and phase difference) of the uniform retarder in the vertical direction is uniform. Thereby, the same effect as the second aspect may be attained.

According to a fourth aspect of the present invention, there is provided a polarized light transmission screen capable to rotate a polarization axis of a linearly polarized light. The polarized light transmission screen includes: a unpatterned retarder which rotates a polarization axis of a linearly polarized light having a specific direction, by +45 degrees, wherein retardation property of the uniform retarder in a vertical direction is uniform; and a patterned retarder including first rotation regions which rotate the linearly polarized light by −45 degrees and second rotation regions which rotate the linearly polarized light by +45 degrees, which are aligned alternately along a vertical direction. Thereby, the same effect as the second aspect may be attained.

According to a fifth aspect of the present invention, there is provided a polarized light transmission screen capable to rotate a polarization axis of a linearly polarized light. The polarized light transmission screen includes: a unpatterned retarder which rotates a polarization axis of a linearly polarized light having a specific direction, by −45 degrees, wherein retardation property of the unpatterned retarder in a vertical direction is uniform; and a patterned retarder including first rotation regions which rotate the polarization axis of the linearly polarized light by +45 degrees and second rotation regions which rotate the polarization axis of the linearly polarized light by −45 degrees, which are aligned alternately along a vertical direction. Thereby, the same effect as the second aspect may be attained.

According to a sixth aspect of the present invention, there is provided a polarized light transmission screen capable to rotate a polarization axis of a linearly polarized light. The polarized light transmission screen includes: a patterned retarder alternately including along a vertical direction: first rotation regions of which an optical axis forms ±22.5 degrees with respect to the polarization axis of the linearly polarized light emitted into the polarized light transmission screen and having a polarization axis of a specific direction; and second rotation regions of which an optical principle axis forms ±45 degrees with respect to the optical axis of the first rotation regions, wherein the first rotation regions and the second rotation regions are consist of half-wave retarders; and a unpatterned retarder, which consists of a half-wave retarder of which a direction of an optical axis is uniform in the vertical direction, wherein a direction of the optical axis is perpendicular to the optical axis of the first rotation regions. Thereby, the same effect as the second aspect may be attained.

From the second to sixth aspects, it is preferable that the wavelength dispersion property of the first rotation region and the wavelength dispersion property of the unpatterned retarder are the same as each other. Thereby, the wavelength dispersion property of the polarized light transmitted through the first rotation region is canceled with sufficient accuracy by the unpatterned retarder.

According to a seventh aspect of the present invention, there is provided a polarized light transmission screen from the second to sixth aspects; a light source; a liquid crystal panel, which is provided between the light source and the polarized light transmission screen and faces the polarized light transmission screen, wherein the liquid crystal panel includes display regions for a left eye capable to display an image for the left eye corresponding to one of the first rotation regions and the second rotation regions, and display regions for a right eye capable to display an image for the right eye corresponding to the other one of the first rotation regions and the second rotation regions, wherein the display regions for the left eye and display regions for the right eye are aligned alternately in a vertical direction, and the liquid crystal panel emit only a linearly polarized light having a specific direction into the polarized light transmission screen; and a polarized glasses including: a polarizer for a right eye capable to absorb the linearly polarized light transmitted through the display regions for the left eye and the polarized light transmission screen, and to transmit the linearly polarized light transmitted through the display regions for the right eye and the polarized light transmission screen; and a polarizer for a left eye capable to absorb the linearly polarized light transmitted through the display regions for the right eye and the polarized light transmission screen, and to transmit the linearly polarized light transmitted through the display regions for the left eye and the polarized light transmission screen. Thereby, the same effect as the second aspect may be attained.

In the stereoscopic image displaying apparatus, when the display regions for the right eye correspond to the first rotation regions, the polarizer for the right eye may include a polarized light absorption axis perpendicular to a polarization axis of the linearly polarized light emitted from the liquid crystal panel, and the polarizer for the left eye may include a polarized light absorption axis parallel to a polarization axis of the linearly polarized light emitted from the liquid crystal panel.

In the stereoscopic image displaying apparatus, when the display regions for the left eye correspond to the first rotation regions, the polarizer for the left eye may include a polarized light absorption axis perpendicular to a polarization axis of the linearly polarized light emitted from the liquid crystal panel, and the polarizer for the right eye may include a polarized light absorption axis perpendicular to a polarization axis of the linearly polarized light emitted from the liquid crystal panel.

According to an eighth aspect of the present invention, there is provided a stereoscopic image displaying apparatus. The stereoscopic image displaying apparatus includes: a polarized light transmission screen of the second or sixth aspect; a separate-type polarized light separately including a light source for a right eye capable to irradiate a linearly polarized light for the right eye and a light source for a left eye capable to irradiate a linearly polarized light for the left eye, on the either side; a collimator capable to project the linearly polarized light for the left eye in a direction of the observer's left eye while projecting the linearly polarized light for the right eye in a direction of the observer's right eye; and a liquid crystal panel which includes: display regions for a right eye transmitting only the linearly polarized light of which polarization axis is parallel to the polarization axis of the linearly polarized light irradiated from the light source for the right eye to display an image for the right eye in a position corresponding to the first rotation regions; and display regions for a left eye capable to display an image for the left eye in a position corresponding to the second rotation regions, wherein the display regions for the right eye and the display regions for the left eye are aligned alternately in a vertical direction. Thereby, the same effect as the second aspect may be attained.

According to a ninth aspect of the present invention, there is provided a stereoscopic image displaying apparatus. The stereoscopic image displaying apparatus includes: a polarized light transmission screen of the second or sixth aspect; a separate-type polarized light separately including a light source for a right eye capable to irradiate a linearly polarized light for the right eye and a light source for a left eye capable to irradiate a linearly polarized light for the left eye, on the either side; a collimator capable to project the linearly polarized light for the left eye in a direction of the observer's left eye while projecting the linearly polarized light for the right eye in a direction of the observer's right eye; and a liquid crystal panel which includes: display regions for a left eye transmitting only the linearly polarized light of which polarization axis is parallel to the polarization axis of the linearly polarized light irradiated from the light source for the left eye to display an image for the left eye in a position corresponding to the first rotation regions; and display regions for a right eye capable to display an image for the right eye in a position corresponding to the second rotation regions, wherein the display regions for the right eye and the display regions for the left eye are aligned alternately in a vertical direction. Thereby, the same effect as the second aspect may be attained.

In the stereoscopic image displaying apparatus the collimator may include: a first linear Fresnel lens which includes ridgelines extended along a direction perpendicular to the polarization axis of the linearly polarized light for the right eye; and a second linear Fresnel lens which includes a ridgeline extended along a direction parallel to the polarization axis of the polarized light for the right eye, wherein the first linear Fresnel lens and the second linear Fresnel lens may be stacked in pile in a traveling direction of the linearly polarized light. In this case, the collimator does not make the components of P wave and S wave of a light to be refracted simultaneously. Therefore, the linearly polarized light is neither rotated its polarization axis nor turned into elliptically polarized light. Therefore, the linearly polarized light for the left eye and the linearly polarized light for the right eye are separable with high precision with the polarizer.

In the stereoscopic image displaying apparatus the collimator may include: a first cylindrical lens which includes ridgelines extended along a direction perpendicular to the polarization axis of the linearly polarized light for the right eye; and a second cylindrical lens which includes a ridgeline extended along a direction parallel to the polarization axis, wherein the first cylindrical lens and the second cylindrical lens are stacked in pile in a traveling direction of the linearly polarized light. Also in this case, the collimator does not make the components of P wave and S wave of a light to be refracted simultaneously. Therefore, the polarization axis of the incident linearly polarized light is neither rotated its polarization axis nor turned into the elliptically-polarized light. Therefore, the linearly polarized light for the left eye and the linearly polarized light for the right eye are separable with high precision with the polarizer.

The summary of the invention does not necessarily describe all necessary features of the present invention. The present invention may also be a sub-combination of the features described above.

### BRIEF DESCRIPTION OF THE DRAWINGS

FIG. 1 is a split-apart perspective view showing a configuration of a stereoscopic image displaying apparatus 100a which employs a glassless system according to the present embodiment.

FIG. 2 shows image data displayed on a displaying unit 46.

FIG. 3 is a conceptual diagram showing principle of the stereoscopic image displaying apparatus 100a separately projecting the light from a separate-type polarized light source 10 onto a left eye and a right eye.

FIG. 4 shows principle of the stereoscopic image displaying apparatus 100a separately projecting an image for the left eye and an image for the right eye on the left eye and the right eye of an observer.

FIG. 5 is a cross sectional view exemplary showing a configuration of a diffuser 50.

FIG. 6 is a split-apart perspective view showing a first embodiment of a stereoscopic image displaying apparatus 100b which employs a glasses system according to the present embodiment.

FIG. 7 is a split-apart perspective view showing a second embodiment of the stereoscopic image displaying apparatus 100b which employs the glasses system according to the present embodiment.

FIG. 8 shows an application of the stereoscopic image displaying apparatus 100b shown in FIG. 7.

FIG. 9 is a drawing showing a process in which a polarized light transmission screen 30 rotates a polarization axis of a linearly polarized light projected on the right eye in steps.

FIG. 10 is a drawing showing a process in which the polarized light transmission screen 30 rotates a polarization axis of a linearly polarized light projected on the left eye in steps.

### DETAILED DESCRIPTION OF THE INVENTION

The invention will now be described based on the embodiments hereinafter, which do not intend to limit the scope of the present invention as defined in the appended claims. All of the features and the combinations thereof described in the embodiments are not necessarily essential to the invention.

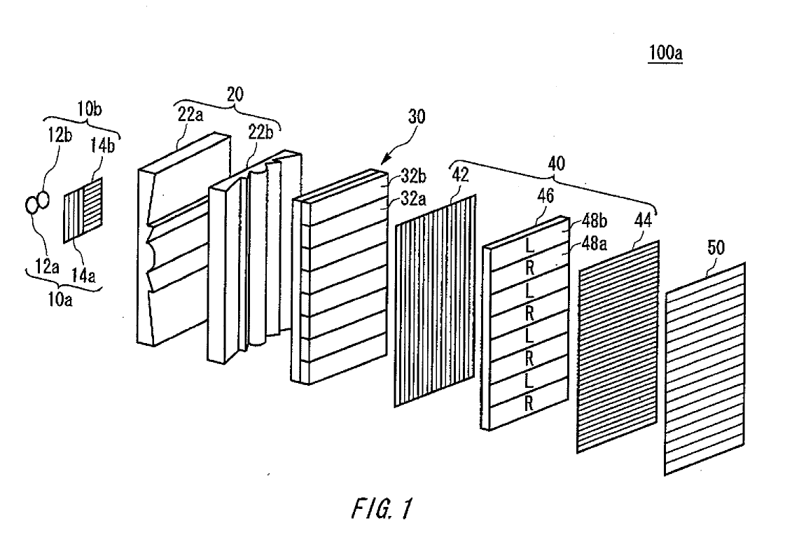

FIG. 1 is a split-apart perspective view showing a configuration of a stereoscopic image displaying apparatus 100a which employs a glassless system according to the present embodiment. The stereoscopic image displaying apparatus 100a includes a separate-type polarized light source 10, a collimator 20, a polarized light transmission screen 30, a liquid crystal panel 40, and a diffuser 50. In the stereoscopic image displaying apparatus 100a, a polarized light for the left eye is emitted from the separate-type polarized light source 10 to display an image for a left eye on the liquid crystal panel 40, and is transmitted through it to project the image onto an observer's left eye. Simultaneously, a polarized light for the left eye is emitted from the separate-type polarized light source 10 to display an image for a right eye on the liquid crystal panel 40, and is transmitted through it to observer's right eye. At this time, a clear stereoscopic image with little cross talk can be displayed to the observer by realizing a highly precise optical property in which the polarized light projected on the left eye is not transmitted through the area of liquid crystal panel displaying the image for the right eye, or the polarized light projected on the right eye is not transmitted through the area of liquid crystal panel displaying the image for the left eye.

The separate-type polarized light source 10 separately include a separate-type polarized light source 10b for a left eye which emits the linearly polarized light for the left eye, and a separate-type polarized light source 10a for a right eye which irradiates the linearly polarized light for the right eye, on the either side. The separate-type polarized light source 10b is located on a right side seen from the observer, and the separate-type polarized light source 10a is located on a left side seen from the observer. The separate-type polarized light source 10b for the left eye includes a separated light source 12b for the left eye and a polarizer for the left eye 14b, and the separate-type polarized light source 10a for the right eye includes a separated light source 12a for the right eye and a polarizer for the right eye 14a. The separated light source 12 is a point light source, and irradiates an unpolarized light. In addition to the point tight source, the separated light sources 12 may be a surface light source such as organic electroluminescence. A transmission axis of polarizer for the left eye 14b is determined so that it is perpendicular to a transmission axis of the polarizer for the right eye 14a. For example, in this embodiment, the polarizer for the left eye 14b includes a horizontal transmission axis, and the polarizer for the right eye 14a includes a vertical transmission axis. Therefore, the polarizer for the left eye 14b emits a linearly polarized light which includes a horizontal polarization axis, and the polarizer for the right eye 14a emits a linearly polarized light which includes a vertical polarization axis.

The collimator 20 includes in piles a first linear Fresnel lens 22a which includes a ridgeline extended along a direction perpendicular to the polarization axis of the linearly polarized light for the right eye, i.e., a horizontal direction, and a second linear Fresnel lens 22b which includes a ridgeline extended along a direction parallel to the polarization axis of the linearly polarized light for the right eye, i.e., a vertical direction. In this case, the first linear Fresnel lens 22a refracts the linearly polarized light for the right and left eyes to the vertical direction, and the second linear Fresnel lens 22b refracts the linearly polarized light for the right and left eyes to the horizontal direction. The above-mentioned first and second linear Fresnel lenses 22a and 22b may change their order with each other. Moreover, the first and second linear Fresnel lenses 22a and 22b may be assembled them in contact or with interspaces. By the above configuration, the collimator 20 projects the linearly polarized light for the left eye emitted from the separated polarizer 14b to the direction of the observer's left eye while projecting the linearly polarized light for the right eye emitted from the separated polarizer 14a to the direction of the observer's right eye.

The liquid crystal panel 40 includes a displaying unit 46, in which display regions 48b for the left eye which display an image for the left eye and display regions 48a for the right eye which display an image for the right eye are alternately aligned, and a first polarizer 42 which is provided on a side of the light source the displaying unit 46 and includes a transmission axis parallel to a transmission axis of the polarizer for the right eye 14a. The first polarizer 42 emits only the linearly polarized light of which polarization axis is parallel to the polarization axis of the linearly polarized light emitted from the separate-type polarized light source 10a for the right eye to be entered onto the displaying unit 46. In addition, the liquid crystal panel 40 further includes a second polarizer 44 which is set on a side of the observer of the displaying unit 46, and transmits only the linearly polarized light having the polarization axis of the specific direction.

The direction of the transmission axis of the second polarizer 44 changes by whether the display specification of the liquid crystal panel 40 is either normally black or normally white. For example, in the case of normally black, the transmission axis of the second polarizer 44 is made parallel to the transmission axis of the first polarizer 42. On the other hand, in the case of normally white, the transmission axis of the first polarizer 42 is made perpendicular to the transmission axis of the second polarizer 44. This embodiment explains the case where the transmission axis of the first polarizer 42 is made perpendicular to the transmission axis of the second polarizer 44 as an example. The liquid crystal panel 40 is formed nearer to the observer side than the collimator 20. Therefore, the stereoscopic image display 100a can display a high resolution image to the observer, since the pixel pitch of the liquid crystal panel 40 is not necessary to be extended.

The polarized light transmission screen 30 includes 0-degree rotation regions 32a which correspond to the display regions 48a for the right eye and is set on the light source side than the liquid crystal panel 40, and 90-degree rotation regions 32b which correspond to the display regions 48b for the left eye, in which the 0-degree rotation regions 32a and the 90-degree rotation regions 32b are alternately aligned along vertical direction. The 0-degree rotation regions 32a emits the linearly polarized light emitted from each of the separate-type polarized light sources 10 without rotating the polarization axis of the linearly polarized light. The 90-degree rotation region 32b rotates the polarization axis of the linearly polarized light emitted from each of the separate-type polarized light sources 10b by ±90 degrees, respectively, and emits it.

The 90-degree rotation regions 32b include multi-layers of retarders which the directions of the optical principal axes differ with one another, and when the linearly polarized light having polarization axis in a specific polarization axis by 90 degrees in total. On the other hand, the 0-degree rotation regions 32a include multi-layers of retarders of which the directions of the optical principal axes differ with one another, and when the linearly polarized retarder to the last, they rotate the polarization axis to the both positive and negative directions with the same degrees so that the direction of the polarization axis is the same at entering and exiting. In this case, a plurality of retarders emit the linearly polarized light in the same direction as at the time of the incidence by rotating the polarization axis to the both positive and negative directions by the same degree.

The 90-degree rotation region 32b rotates the polarization axis by 90 degrees with a wavelength dispersion property lower than the case where the polarization axes of the linearly polarized light are rotated 90 degrees at once with single retarder. Similarly, since the 0-degree rotation region 32a rotates the polarization axis to the both positive and negative directions by the same degree, it can contradict the wavelength dispersion property. That is, the polarized light transmission screen 30 can reduce the wavelength dispersion property of both polarization axes of the linearly polarized lights which are transmitted through the 90-degree rotation region 32b and through the 0-degree rotation region 32a, thereby they are made perpendicular with each other.

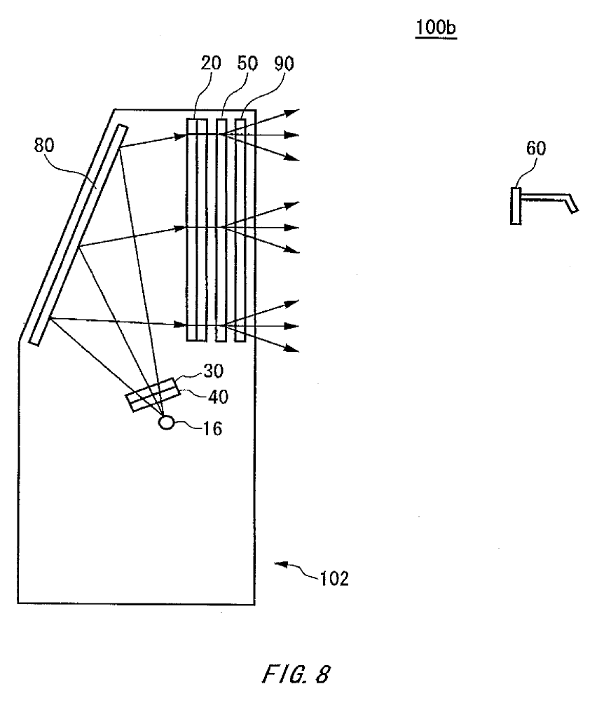

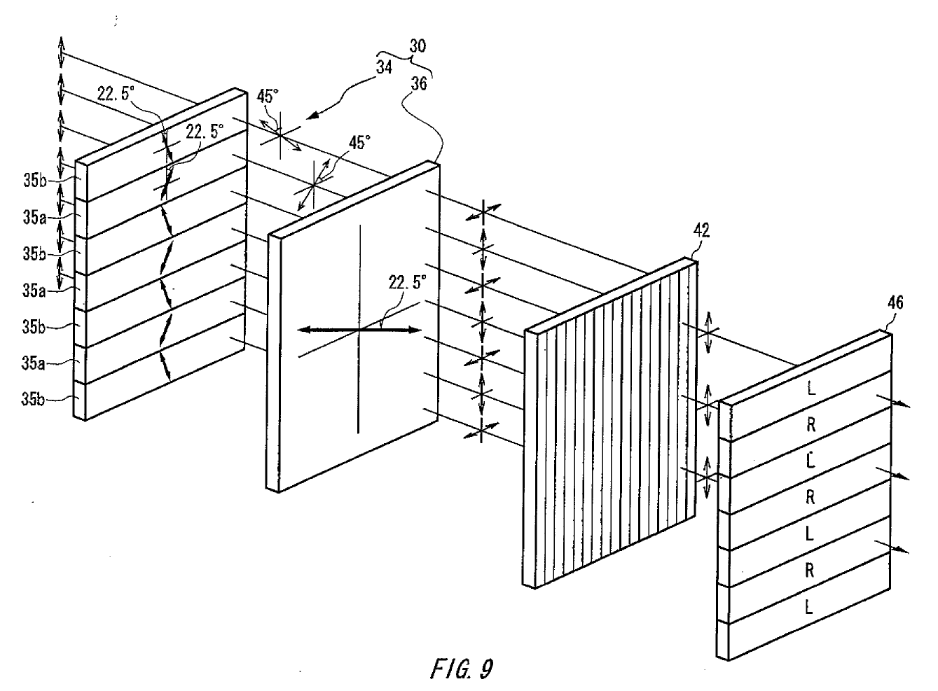

At least one of the retarders of the 90-degree rotation regions 32b and the 0-degree rotation regions 32a is the in patterned retarder. If it is the unpatterned retarder, since it is not necessary to align the retarder to an other retarder in terms of its optical property, the dispersion in the optical property of the polarized light transmission screen 30 by the alignment error among the plurality of retarders can be reduced. About the detailed configuration of the polarized light transmission screen 30, it will be explained later with reference to FIGS. 8 and 9.

The diffuser 50 diffuses image light only in the vertical direction. By this, only a viewing angle in the vertical direction can be extended without emitting the image light for the left eye on the right eye, or emitting the image light for the right eye on the left eye. The diffuser 50, which diffuses image light in vertical direction, is for example a matte surface diffuser, or a lenticular lens sheet. In the case of the mat surface diffuser, horizontally extending fine irregularity is formed on the surface of the diffuser 50 by some techniques, such as sandblasting which gives rough surface, painting method or printing method which deposits transparent ink on a part of the surface, for example. In the case of the lenticular lens sheet, the diffuser 50 includes an array of horizontally-extending half-cylindrical lenses along the vertical direction.

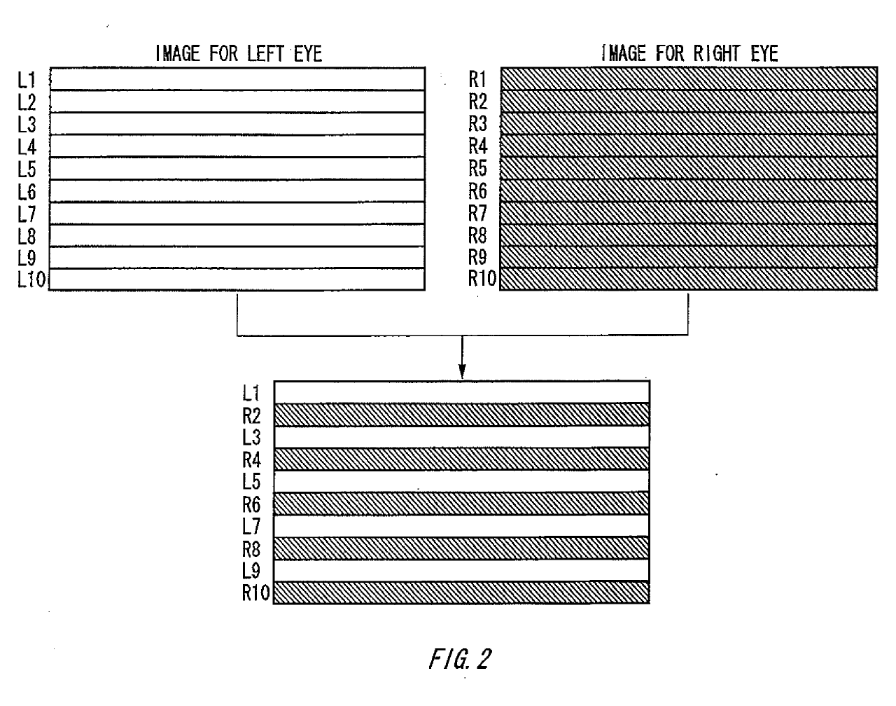

FIG. 2 shows image data displayed on a displaying unit 46 according to the present embodiment. An image for the left eye which consists of scanning lines L1-L10, and an image for the right eye which is consisted of scanning lines R1-R10 are combined, and image data for a stereoscopic image displayed on the displaying unit 46 is generated. The image data for the left eye and the image data for the right eye are photographed using a stereoscopic camera which photographs two images simultaneously. The odd-numbered scanning line data of the image data for the left eye and the even-numbered scanning line data of the image data for the right eye are extracted, respectively, and the alternately combined image is displayed on the displaying unit 46. The even-numbered scanning line data of the image data for the left eye and the odd-numbered scanning line data of the image data for the right eye are not displayed on the displaying unit 46. A display regions 48a for the right eye and a display regions 48b for the left eye of the displaying unit 46 correspond to the scanning lines (R2, R4, R6 . . . ) of the image for the right eye and the scanning lines (L1, L3, L5 . . . ) of the image for the left eye, respectively.

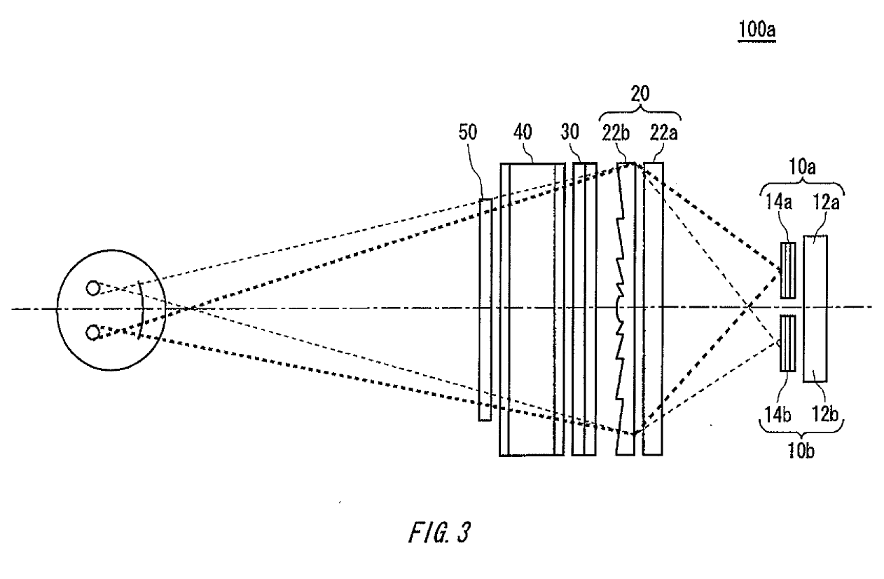

FIG. 3 is drawing showing the principle by which the light from the separate-type polarized light source 10 is separately projected on the left and right eyes, respectively in the stereoscopic image displaying apparatus 100a. The polarized light source for the right eye 10a and the polarized light source for the left eye 10b are separated to the right side and the left side of the center line along the optical axis of the linear Fresnel lens 22b, which refracts light to horizontal direction. Therefore, the light from the separate-type polarized light source 10b provided on the right side of the Fresnel lens's optical axis seen from the observer is projected by the linear Fresnel lens 22b on the left side of the optical axis, i.e., the direction of the observer's left eye. On the other hand, the light from the separate-type polarized light source 10a provided on the left side of the Fresnel lens's optical axis seen from the observer is projected through the linear Fresnel lens 22b on the right side of the center line along its optical axis, i.e., to the direction of the observer's right eye. By this, the light from the separate-type polarized light source 10b for the left eye is projected to the direction of the observer's left eye, and the light from the separate-type polarized light source 10a for the right eye is projected to the direction of the observer's right eye, respectively.

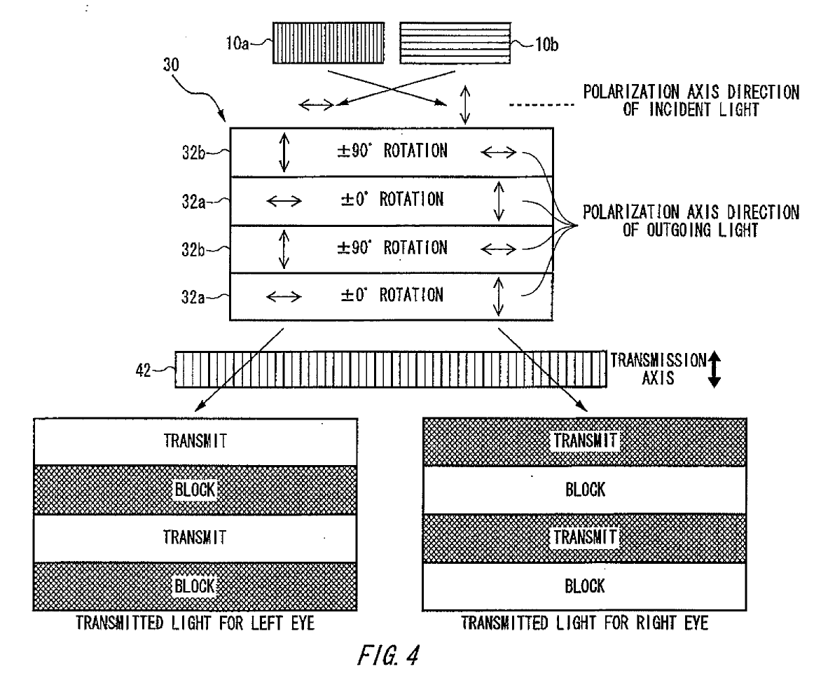

FIG. 4 shows conceptually the principle by which the image for the left eye and the image for the right eye are separately projected on the left and right eyes of the observer in the stereoscopic image displaying apparatus 100a of FIG. 1. First, the linearly polarized lights emitted from a the separate-type polarized light source 10a for the right eye include vertical polarization axes, and are projected to the direction of the observer's right eye with the collimator 20. Some of these linearly polarized lights emitted to the 0-degree rotation regions 32a are emitted from the polarized light transmission screen 30 in which the direction of the polarization axis remains the same, i.e., in the vertical direction, and the other linearly polarized lights emitted to the 90-degree rotation regions 32b are emitted in which the direction of the polarization axis rotates ±90 degrees, i.e., in the horizontal direction. The first polarizer 42 transmits the linearly polarized light which is transmitted through the polarized light transmission screen 30, and of which polarization axis is perpendicular to the polarization axis of the first polarizer 42, and absorbs the linearly polarized light which is transmitted through the polarized light transmission screen 30, and of which polarization axis is parallel to the polarization axis of the first polarizer 42. Therefore, while transmitting the linearly polarized light, which is transmitted through the 0-degree rotation region 32a, the linearly polarized light which is transmitted through the 90-degree rotation region 32b is absorbed. Therefore, the linearly polarized lights for the right eye are emitted to the display regions 48a for the right eye provided corresponding to the 0-degree rotation regions 32a, and the linearly polarized lights for the right eye are not emitted to the display regions 48b for the left eye provided corresponding to the 90-degree rotation regions 32b. By this, the linearly polarized lights from the separate-type polarized light source 10a for the right eye is emitted to only the display regions 46a for the right eye, and it projects only the image light for the right eye on the observer's right eye.

On the other hand, the linearly polarized lights emitted from the separate-type polarized light source 10b for the left eye include horizontal polarization axes, and are projected to the direction of the observer's left eye through the collimator 20. Among these, the linearly polarized lights emitted to the 0-degree rotation region 32a are emitted from the polarized light transmission screen 30 in which the direction of the polarization axes remains the same, i.e., in the horizontal direction, and the linearly polarized lights emitted to the 90-degree rotation region 32b are emitted in which the direction of the polarization axes rotates ±90 degrees, i.e., the vertical direction. Therefore, while the linearly polarized light for the left eye which is transmitted through the 0-degree rotation region 32a is transmitted through the first polarizer 42, the linearly polarized light for the left eye which is transmitted through the 90-degree rotation region 32b is absorbed by the first polarizer 42. That is, the linearly polarized lights for the left eye are emitted to the display regions 48b for the left eye provided corresponding to the 90-degree rotation regions 32b, and the linearly polarized lights for the left eye are not emitted to the display regions 48a for the right eye provided corresponding to the 0-degree rotation regions 32a. By this, the linearly polarized lights from the separate-type polarized light source 10b for the left eye is emitted to only the display regions 48b for the left eye, and it projects only the image light for the left eye to the observer's left eye. Thereby, a stereoscopic image can be displayed to the observer.

Here, in the collimator 20, the first linear Fresnel lens 22a and the second linear Fresnel lens 22b include ridgelines extended in perpendicular to or parallel to the polarization axes of the linearly polarized lights for the right and left eyes, respectively, as shown in FIG. 1. In this case, the collimator 20 does not refract the components of P wave and S wave simultaneously which comprise one linearly polarized light emitted from the separate-type polarized light source 10a or 10b. Consequently, the collimator 20 can project the linearly polarized light ahead without rotating its polarization axis or turning it into the elliptically-polarized light. Therefore, the first polarizer 42 can filter the light projected from the collimator 20 with high precision. That is, the stereoscopic image displaying apparatus 100a according to the present embodiment can absorb the linearly polarized light which is to be absorbed with high absorption level, and can transmit the linearly polarized light in high transmittance. It is preferable that the material used for the collimator 20 has smaller retardation value. It is preferable that the retardation value is 20 nm or less, for example. By this, elliptical polarizing of the linearly polarized light, which is transmitted through the collimator 20 by birefringence, is prevented.

In addition, the first polarizer 42 may emit only the linearly polarized light, which has a transmission axis parallel to the transmission axis of the polarizer for the left eye 14b and is emitted from the separate-type polarized light source 10b for the left eye, to the displaying unit 46. In this case, the 90-degree rotation region 32b is provided nearer to the light source than the liquid crystal panel 40 corresponding to the display region 48a for the right eye, and the 0-degree rotation region 32a is provided corresponding to the display region 48b for the left eye.

Moreover, as another embodiment, the polarizer for the left eye 14b may include a vertical transmission axis, and the polarizer for the right eye 14a may include a horizontal transmission axis. In this case, the 0-degree rotation regions 32a are provided corresponding to the display regions 48b for the left eye, and the 90-degree rotation regions 32b are provided corresponding to the display regions 48a for the right eye. Alternatively, like the above-mentioned example, the 0-degree rotation regions 32a and the 90-degree rotation regions 32b may be provided corresponding to the display regions 48a for the right eye and the display regions 48b for the left eye, respectively, and may rotate the transmission axis direction of the first polarizer 42 and the second polarizer 44 by 90 degrees from the above-mentioned example. That is, the first polarizer 42 may direct the transmission axis to the horizontal direction, and the second polarizer 44 may direct the transmission axis to the vertical direction.

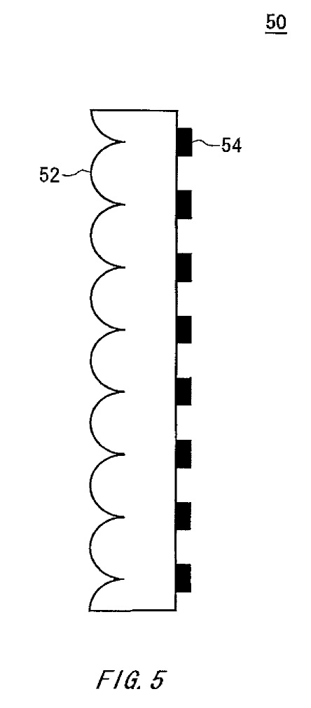

FIG. 5 is a vertical cross sectional view exemplary showing the configuration of the diffuser 50. The diffuser 50 includes a lenticular lens sheet 52 on the light source side. The lenticular lens sheet 52 includes an array of half-cylindrical convex lenses extended in the horizontal direction. The lenticular lens sheet 52 diffuses image light to the vertical direction. Thereby, the viewing angle in the vertical direction increases. Moreover, the light absorbing layer 54 is formed at the outside of the optical path of the image light on the observer side of the diffuser 50. The light absorbing layer 54 includes light absorbing substances, such as carbon black, and while reducing the transmittance of light other than the image light which emitted from light source side, it prevents the reflection of light emitted from the observer side. Thereby, the contrast of the image can be improved. In addition, substances which have a certain level of light absorbing effect can be used for the light absorbing substance. For example it may be paint, a light absorbing film, and the like.

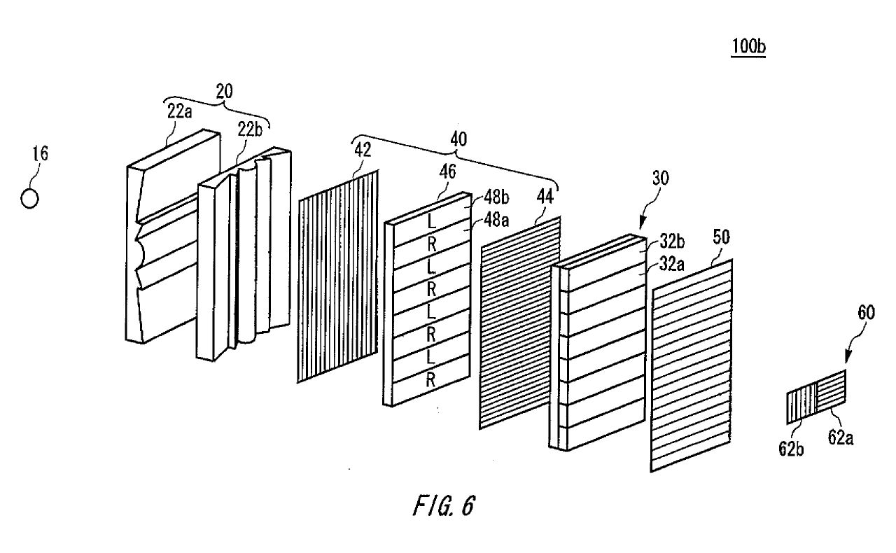

FIG. 6 is a split-apart perspective view showing a first embodiment of the stereoscopic image displaying apparatus 100b which employs a glasses system according to the present embodiment. The stereoscopic image displaying apparatus 100b includes a light source 16 instead of the separate-type polarized light source 10 of the above-mentioned stereoscopic image displaying apparatus 100a, and includes a polarized light transmission screen 30 nearer the observer side than the liquid crystal panel 40, which is provided on the light source side of the stereoscopic image displaying apparatus 10a. Furthermore, unlike the stereoscopic image displaying apparatus 100a, polarized glasses 60 for observers are included. Hereinafter, the same reference numeral is given to the same component as the stereoscopic image displaying apparatus 100a, and their explanation will be omitted.

The light source 16 emits unpolarized light ahead. In addition to the point light source, the light source 16 may be a surface light source such as organic electroluminescence. The collimator 20 collimates the light emitted from the light source 16 to the parallel light and to emit it to the liquid crystal panel 40, and projects it towards the front of the stereoscopic image displaying apparatus 100b at the same magnification as the image displayed of the liquid crystal panel 40. The liquid crystal panel 40 is provided nearer the observer side than the collimator 20. The polarized glasses 60 include a polarizer 62a for the right eye which transmits only the linearly polarized light which projects the image for the right eye, and a polarizer 62b for the left eye which transmits only the linearly polarized light which projects the image for the left eye.

In the collimator 20, the ridgelines of the first linear Fresnel lens 22a are directed to the horizontal direction and refract the light in the vertical direction. Moreover, the ridgelines of the second linear Fresnel lens 22b are directed to the vertical direction and refract the light in the horizontal direction. In the liquid crystal panel 40, the transmission axis of the first polarizer 42 is along the vertical direction, and only the linearly polarized light with a vertical polarization axis is transmitted.

In the polarized light transmission screen 30, the 0-degree rotation regions 32a emit the linearly polarized light which is transmitted through the display regions 48a for the right eye without rotating the polarization axis, and the 90-degree rotation regions 32b rotate the polarization axis of the linearly polarized light which is transmitted through the display regions 48b for the left eye by ±90 degrees.

In the polarized glasses 60, the transmission axis of the polarizer 62a for the right eye is provided parallel to the transmission axis of the second polarizer 44. Therefore, after passing through the display regions 48a for the right eye and the second polarizer 44, the linearly polarized light which is transmitted through the 0-degree rotation regions 32a with the same direction of its polarization axis as at the incidence, reaches the right eye. Then, after passing through the display regions 48b for the left eye and the second polarizer 44, the linearly polarized light, of which polarization axis is rotated by 90 degrees by the 90-degree rotation regions 32b, is absorbed. On the other hand, the transmission axis of the second polarizer 44 is made perpendicular to the transmission axis of the polarizer 62b for the left eye. Therefore, after passing through the display region 48b for the left eye and the second polarizer 44, the linearly polarized light, which is rotated by 90 degrees by the 90-degree rotation region 32 breaches the left eye. Then, after passing through the display region 48a for the right eye and the second polarizer 44, the linearly polarized light, which is transmitted through the 0-degree rotation region 32a with the same direction of its polarization axis as at the incidence, is absorbed.

As another embodiment, the 0-degree rotation regions 32a may be provided corresponding to the display regions 48b for the left eye, and the 90-degree rotation regions 32b may be provided corresponding to the display regions 48a for the right eye. That is, the 0-degree rotation regions 32a may emit the linearly polarized light emitted from the display regions 48b for the left eye without rotating the polarization axis, and the 90-degree rotation regions 32b may rotate by ±90 degrees and emit the linearly polarized light emitted from the display regions 48a for the right eye. In this case, in the polarized glasses 60, the transmission axis of the second polarizer 44 is made perpendicular to the transmission axis of polarizer 62a for the right eye. Thereby, after being transmitted through the display region 48a for the right eye and the second polarizer 44, the polarizer 62a rotates the polarization axis of the linearly polarized light by ±90 degrees by the 90-degree rotation region 32b and makes it reach the right eye. Then, after being transmitted through the display region 48b for the left eye and the second polarizer 44, the linearly polarized light, which is transmitted through the 0-degree rotation region 32a with the same direction of its polarization axis as at the incidence, is absorbed. On the other hand, the transmission axis of the polarizer 62b for the left eye is parallel to the transmission axis of the second polarizer 44. Thereby, after being transmitted through the display regions 48b for the left eye and the second polarizer 44, the polarizer 62b for the left eye rotates the polarization axis of the linearly polarized light which is transmitted through the 0-degree rotation region 32a of which direction of the polarization axis is the same at entering and exiting and rotates the polarization axis of the linearly polarized light, which is transmitted through the 0-degree rotation region 32a with the same direction of the polarization axis at entering and exiting, to be reached to the left eye. Then, after being transmitted through the display region 48a for the right eye and the second polarizer 44, the linearly polarized light rotated by ±90 degrees by the 90-degree rotation regions 32 is absorbed.

By the above configuration, in the stereoscopic image displaying apparatus 100b, the lights for the left and right images reach the observer's left and right eyes strictly separately.

In addition, in another embodiment of the stereoscopic image displaying apparatus 100b, the transmission axis of the first polarizer 42 may be directed to the horizontal direction. In this case, transmission axes of the second polarizer 44 and the polarized glasses 60 are rotated by 90 degrees with respect to the above-mentioned example. That is, the transmission axis of the second polarizer 44 is directed to the vertical directions the transmission axis of the polarizer 62a for the right eye is directed to the vertical direction, and the transmission axis of the polarizer 62b for the left eye is directed to the horizontal direction. Alternatively, by changing the positions of the 0-degree rotation regions 32a and the 90-degree rotation regions 32b, the direction of the transmission axis of the polarized glasses 60 may be the same as that of the above-mentioned example. That is, the 90-degree rotation regions 32b are provided corresponding to the display regions 48a for the right eye, and the 0-degree rotation regions 32a are provided corresponding to the display regions 48b for the left eye. In this case, the transmission axis of the polarizer 62a for the right eye and the polarizer 62b for the left eye are directed to the horizontal direction and the vertical direction, respectively, like the above-mentioned example.

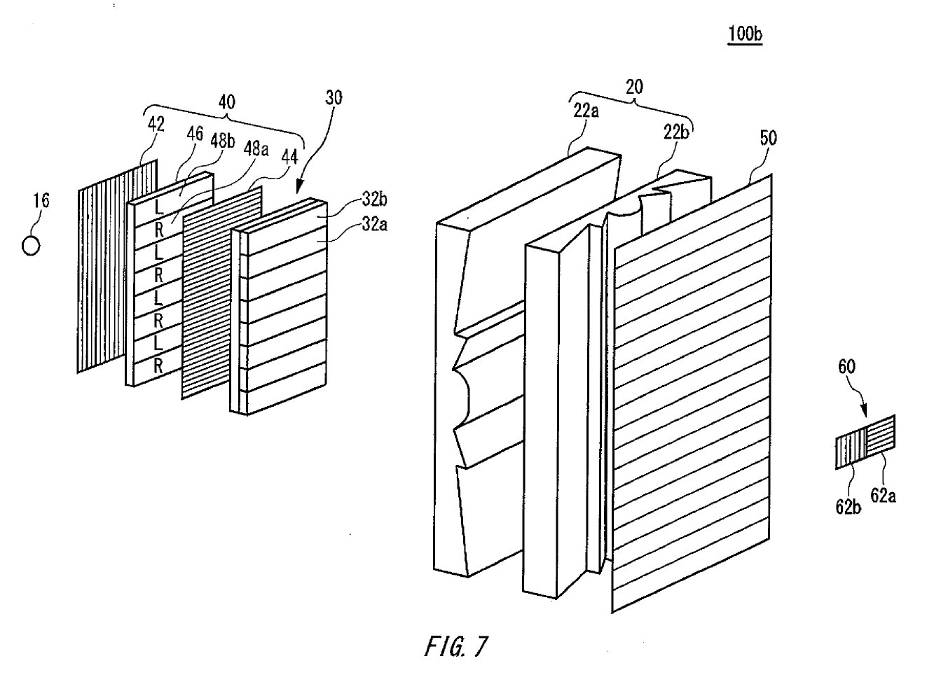

FIG. 7 is a split-apart perspective view showing a second embodiment of the stereoscopic image displaying apparatus 100b by the glasses system according to the present embodiment. The stereoscopic image displaying apparatus 100b of this embodiment projects the magnified image displayed on the liquid crystal panel 40 ahead by the light emitted from the light source 16, and collimates the image light magnified to desired size with the collimator 20. The stereoscopic image displaying apparatus 100b of this embodiment differs from the first embodiment with respect to assembling shown in FIG. 6 with the point that the collimator 20 is formed nearer the observer side than the polarized light transmission screen 30. In addition, the same reference numeral is given to the same component as the first embodiment, and their explanation will be omitted.

The transmission axis of the second polarizer 44 is directed to the horizontal direction, and only horizontal linearly polarized light is transmitted among the lights which is transmitted through the displaying unit 46. In the polarized light transmission screen 30, the 90-degree rotation regions 32b are provided in the position corresponding to the display regions 48b for the left eye, i.e., in the position at which the image light transmitted through the display region 48b for the left eye is emitted. Therefore, the linearly polarized light, which is transmitted through the display regions 48b for the left eye and the second polarizer 44, is rotated by ±90 degrees by the 90-degree rotation region 32b and is emitted. On the other hand, the 0-degree rotation regions 32a are provided in the position corresponding to the display regions 48a for the right eye, i.e., the position at which the image light transmitted through the display region 48a for the right eye is emitted. Therefore, the linearly polarized light, which is transmitted through the display region 48a for the right eye and the second polarizer 44, is transmitted through the 0-degree rotation region 32a, and is emitted with the same direction of its polarization axis as at the incidence.

The collimator 20 is assembled nearer the observer side than and in the enough distance from the polarized light transmission screen 30 required to magnify and display the image. The collimator 20 collimates the image light magnified by being transmitted through the liquid crystal panel 40 and the polarized light transmission screen 30, and projects it towards the front of the stereoscopic image displaying apparatus 10b. In the collimator 20, each of the first and second linear Fresnel lenses 22a and 22b includes ridgelines parallel to or perpendicular to the polarization axis of the linearly polarized light emitted from the 0-degree rotation region 32a and the 90-degree rotation region 32b. Therefore, the collimator 20 can collimate the linearly polarized light for the observer, without transforming the linear polarization of the image light into the elliptical polarization the linearly polarized light of the image light which is emitted from the 0-degree rotation region 32a and the 90-degree rotation region 32b, respectively. In this state, when the transmission axis of the polarizer for the left eye 62b is perpendicular to the transmission axis of the second polarized 44, and the transmission axis of polarizer for the right eye 62a is parallel to the transmission axis of the second polarizer 44, and by making the transmission axis of polarizer 62a for the right eye parallel to the transmission axis of the second polarizer 44, the image can be displayed for the left and right eyes of the observer separately with high precision. According to the above configuration, a clear stereoscopic image with little cross talk can be provided to an observer, magnifying the image displayed on the liquid crystal panel 40 to the desired size.

In another embodiment, the 90-degree rotation region 32b may be provided corresponding to the display region 48a for the right eye, and the 0-degree rotation region 32a may be provided corresponding to the display region 48b for the left eye. Thereby, the linearly polarized light of the image light, which is transmitted through the display region 48a for the right eye and the second polarizer 44, is rotated ±90 degrees by the 90-degree rotation region 32, and is emitted. On the other hand, the linearly polarized light of the image light, which is transmitted through the display region 48b for the left eye and the second polarizer 44, is transmitted through the 0-degree rotation region 32a with the same direction of its polarization axis as at the incidence. In this case, the transmission axis of the polarizer 62b for the left eye is provided parallel to the transmission axis of the second polarizer 44. Moreover, the transmission axis of the second polarizer 44 is made perpendicular to the transmission axis of polarizer 62a for the right eye. In the polarized glasses 60, the transmission axis of the second polarizer 44 is made perpendicular to the transmission axis of the polarizer 62a for the right eye. Moreover, the transmission axis of the polarizer 62b for the left eye is made parallel to the transmission axis of the second polarizer 44.

Through the polarizer 62a for the right eye, the linearly polarized light which is transmitted through the display region 48a for the right eye and the second polarizer 44, and is rotated by ±90 degrees with the 90-degree rotation region 32b, reaches the right eye. Then, the linearly polarized light, which is transmitted through the display region 48b for the left eye and the second polarizer 44 and transmitted through the 0-degree rotation region 32a without rotating the polarization axis rotated, is absorbed. On the other hand, the polarizer 62b for the left eye makes the linearly polarized light, which is transmitted through the display region 48b for the left eye and the second polarizer 44 and is transmitted through the 0-degree rotation region 32a with the same direction of its polarization axis as at the incidence, reach the left eye. Then, the linearly polarized light, which is transmitted through the display region 48a for the right eye and the second polarizer 44 and rotated by ±90 degrees by the 90-degree rotation region 32, is absorbed.

In addition, the diffuser 50 of this embodiment may diffuse the linearly polarized light to the horizontal direction. Moreover, when the light source 16 is a surface light source having an area substantially equal to that of the liquid crystal panel 40, the stereoscopic image displaying apparatus 100b may include a magnifying lens which magnifies the image light emitted from the liquid crystal panel 40. In this case, it is preferable that the magnifying lens is the linear Fresnel lens 22a and the linear Fresnel lens 22b which include ridgelines perpendicular to or parallel to the polarization axis of the polarized light emitted from the polarized light transmission screen 30. By this, image light can be magnified to the desired size, without rotating the polarization axis of the linearly polarized light emitted from the polarized light transmission screen 30 or turning the linearly polarized into the elliptically polarized light.

FIG. 8 shows an application of the stereoscopic image displaying apparatus 100b shown in FIG. 7. A rear projection display 102 of this embodiment displays the stereoscopic image magnified to the observer wearing the polarized glasses 60. In addition to the configuration of FIG. 7, the rear projection display 102 includes a reflecting mirror 80 which reflects the magnified optical image projected by being transmitted through the liquid crystal panel 40 and the polarized light transmission screen 30 and emits it to a collimator 20 and a front plate 90 provided on the observer side of a diffuser 50. The polarized light transmission screen 30 is assembled in parallel to and in the vicinity of the front surface of the liquid crystal panel 40. The reflecting mirror 80 is tilted with respect to the direction parallel to or perpendicular to the polarization axis of the linearly polarized light which is transmitted through the polarized light transmission screen 30. The front plate 90 reduces reflection of outdoor daylight by antiglare processing such as anti-reflection coating provided on the surface while protecting the collimator 20 and the diffuser 50.

In order to magnify the image displayed on the liquid crystal panel 40 to a desired size on the collimator 20, it is necessary to ensure that the optical path length between the polarized light transmission screen 30 and the collimator 20 is more than a predetermined length. The rear projection display 102 assures the required optical path length without increasing depth of the rear projection display 102 by including the reflecting mirror 80.

Here, since the reflecting mirror 80 is tilted by the angle to be parallel to or perpendicular to the polarization axis of the linearly polarized light of the image for the left eye and the image for the right eye emitted from the polarized light transmission screen 30, the linearly polarized light for the left eye and the image light for the right eye do not have either P wave or S wave simultaneously. Therefore, the reflecting mirror 80 reflects the linearly polarized light of the image for the right eye and the image for the left eye without rotating its polarization axis or turning into the elliptically polarized light, and emits them to the collimator 20. Therefore, for the observer wearing the polarized glasses 60, the rear projection display 102 of this embodiment can provide a stereoscopic image which is magnified to a desired size and has little cross talk.

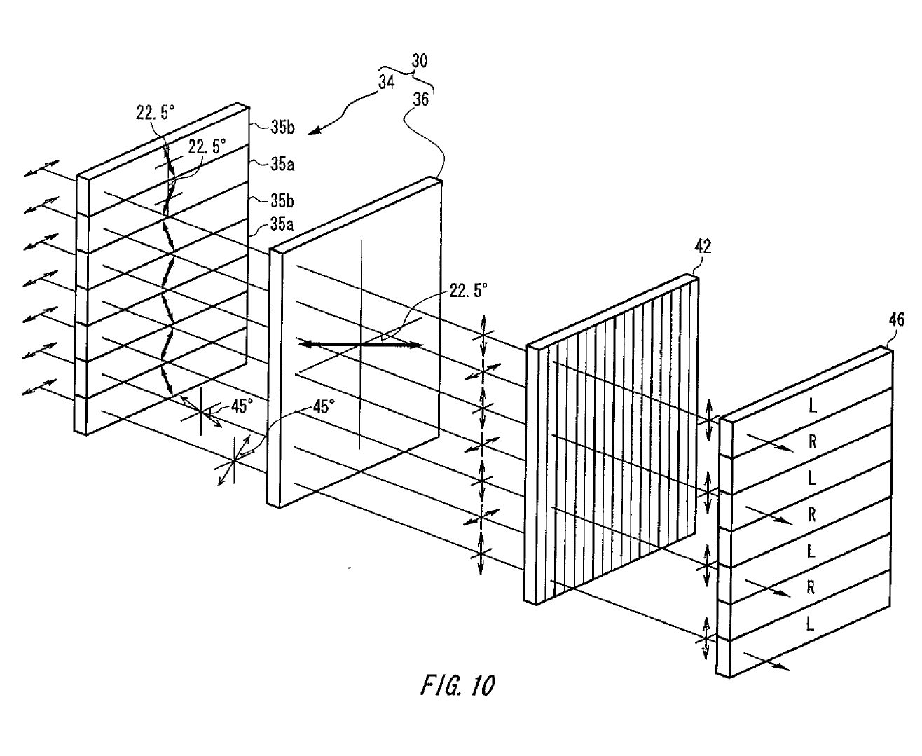

FIGS. 9 and 10 show the configuration of the polarized light transmission screen 30. FIG. 9 further shows a process by which the polarized light transmission screen 30 rotates in steps the linearly polarized light projected on the observer's right eye in the stereoscopic image displaying apparatus 100a of FIG. 1. The polarized light transmission screen 30 includes a patterned retarder 34 and a unpatterned retarder 36 which all consist of half-wave retarders. The patterned retarder 34 includes first rotation regions 35a which correspond to the display regions 48a for the right eye and second rotation regions 35b which correspond to the display regions 48b for the left eye of the liquid crystal panel 40, which are alternately aligned along the vertical direction. The patterned retarder 34 and the unpatterned retarder 36 may be retarders which have the same function as the half-wave retarder, respectively. For example, two ¼ wave retarders may be combined, or four ⅛ wave retarders may be combined.

In this embodiment, the polarization axis of the linearly polarized light emitted from the separate-type polarized light source 10a for the right eye is directed to the vertical direction. Then, the angle of the optical axis of the first rotation regions 35a is made ±22.5 degrees with respect to the polarization axis of a linearly polarized light. The direction of the optical axis of first rotation regions 35a is made ±45 degrees with respect to the optical axis of the second rotation regions 35b. Here, the optical axis means a fast axis or a slow axis of the half-wave retarder. The thick arrows drawn on the patterned retarder 34 and the unpatterned polarization rotating plate 36 show the directions of the optical axes of the half-wave retarder in the drawing. Moreover, the arrows which go through the patterned retarder 34 and the unpatterned retarder 36 show the optical paths of the linearly polarized lights which project the image. Then, the narrow arrows drawn on the optical paths show the directions of the polarization axes of a linearly polarized lights.

The direction of optical axis of the unpatterned retarder 36 is uniform in the vertical direction, and the optical axis is made perpendicular to the optical axis of the first rotation regions 35a. Here, regions corresponding the first rotation regions 35a of the unpatterned retarder 36 and the first rotation regions 35a constitute the above-mentioned 0-degree rotation regions 32a, and regions corresponding to the second rotation regions 35b of the unpatterned retarder 36 and the second rotation regions 35b constitute the 90-degree rotation regions 32b.

The first rotation regions 35a rotate the polarization axis of the linearly polarized light emitted from the separate-type polarized light source 10a for the right eye by +45 degrees. The second rotation regions 35b rotate the polarization axis of the linearly polarized light emitted from the separate-type polarized light source 10a for the right eye by −45 degrees. The unpatterned retarders 36 rotates by −45 degrees both of the polarization axis of the linearly polarized light rotated +45 degrees by the first rotation regions 35a and the polarization axis of the linearly polarized light rotated by −45 degrees by the second rotation regions 35b. In addition, positive direction means clockwise direction and the negative direction means counter clockwise direction seen from traveling direction of the light.

Consequently, the polarization axis of the linearly polarized light which is transmitted through the first rotation regions 35a and the unpatterned retarder 36 is perpendicular to the polarization axis of the linearly polarized light which is transmitted through the second rotation regions 35b and the unpatterned retarder 36. For example, in this embodiment, the polarization axis of the linearly polarized light which is transmitted through the first rotation regions 35a and the unpatterned retarder 36 is directed to the vertical direction, which is the same direction as the time of the incidence to the patterned retarder 34. Then, the polarization axis of the linearly polarized light which is transmitted through the second rotation regions 35b and the unpatterned retarder 36 is directed to the horizontal direction, which is perpendicular to the direction at the time of the incidence to the patterned retarder 34.

Among the lights which are transmitted through the polarized light transmission screen 30, the first polarizer 42 absorbs a linearly polarized light of which the polarization axis is horizontal while transmitting a linearly polarized light with the vertical polarization axis through it. Therefore, light is emitted to the display regions 48a for the right eye corresponding to the first rotation region 35a, and the light is not emitted to the display region 48b for the left eye corresponding to the second rotation region 35b. Thus, the linearly polarized light for the right eye is emitted only to the display regions 48a for the right eye, and it projects the image light for the right eye ahead.

That is, the 90-degree rotation regions 32b rotate the polarization axis of the linearly polarized light emitted from the separate-type polarized light source 10a for the right eye by 90 degrees by rotating it for a plurality of times with a two or more retarders of which the directions of the slow axes differs with one another. In this case, the angle of the slow axis with respect to the incident polarized light changes for every retarder, and the vector components, of which the polarization phases delay, differ between each of the retarders.

In this case, property of chromatic dispersion can be reduced rather than the case where the phase having the same vector component from the time of incidence to exit is continuously delays with a retarder having the uniform direction of a slow axis. Therefore, the polarization axis of the linearly polarized light can be rotated 90 degrees with sufficient accuracy over wide range of wavelengths.

In addition, the 90-degree rotation region 32b may rotate the polarization axis of the linearly polarized light by 90 degrees by three or more retarders. For example, when constituting the 90-degree rotation region 32b from four half-wave retarders, it tilts the first slow axis 11.25 degrees with respect to the horizontal direction, and of each of the second to fourth slow axes is further tilted 22.5 degrees in the same direction, and they are combined with one another. Thus, when the linearly polarized light having horizontal polarized axis is emitted to the 90-degree rotation region 32b from the first plate side, the polarization axis is rotated 22.5 degrees by each of the first to fourth plates and the linearly polarized light rotated 90 degrees is emitted.

Since the direction of the optical axis is uniform, the unpatterned retarder 36 of the present embodiment does not have to make alignment of the patterned retarder 34 in the four directions. What is necessary is to make the direction of the optical axis perpendicular to the optical axis of the first rotation regions 35a. Therefore, the direction of the polarization axis at the time of irradiated from the polarized light transmission screen 30 can be decided according to the position of first rotation regions 35a and second rotation regions 35b, and it is not influenced from the assembly error of the patterned retarder 34 and the unpatterned retarder 36.

Furthermore, in the 0-degree rotation regions 32a, the unpatterned retarder 36 and the first rotation regions 35a rotate the polarization axis of the linearly polarized light emitted from the separate-type polarized light source 10a for the right eye to the opposite direction from each other. Here, the optical axes, i.e., fast axes or the slow axes of the unpatterned retarder 36 and the first rotation region 35a are perpendicular to each other. Therefore, the phase of the component, which is transmitted through the first rotation region 35a and of which the phase is delayed, among the vector components of the incident polarized light, shift ahead by the same phase as retarded against the component of which the phase is not delayed through the first rotation region 35a. Since this is the same also in any visible light wave length region, the wavelength dispersion property generated in either the unpatterned retarder 36 or first rotation regions 35a is cancelled by the other. Moreover, when rotating the polarization axis of the linearly polarized light with two half-wave retarders, and when directions of rotation are opposite and the angles of rotation are equal from/to each other, the chromatic dispersion properties generated by the rotation will have substantially the same absolute values, which have positive and negative values, respectively. Therefore, the wavelength dispersion property generated when each of the unpatterned retarder 36 and the first rotation regions 35a rotates the polarization axis of the linearly polarized light to an opposite direction cancels the other. Here, the patterned retarder 34 and the unpatterned retarder 36 have the same chromatic dispersion properties. Thereby, the wavelength dispersion property of the polarized light rotated by the first rotation region 35a is canceled further accurately by the unpatterned retarder 36.

In addition, the 0-degree rotation regions 32a may consist of three or more retarders. For example, when the 0-degree rotation region 32a consists of four half-wave retarders, the slow axis of the first plate is tilted 11.25 degrees with respect to the horizontal direction, and the slow axis of the second plate is further tilted 22.5 degrees to the same direction. Then the delaying axis of the third plate is made perpendicular to the slow axis of the second plate, and the delaying axis of the fourth plate is made perpendicular to the slow axis of the first plate. When the linearly polarized light which includes its polarization axis in the horizontal direction is emitted from the first plate side of the 0-degree rotation region 32a formed in this way, the polarization axis is rotated 22.5 degree by each of the first and second plates in the same direction, and is oppositely rotated the same angle, i.e., 22.5 degrees each, by the third and fourth plates. Consequently, the direction of the polarization axis of the linearly polarized light is rotated to the same direction as at the time of incidence, i.e., the horizontal direction, and then it is emitted.

As is apparent from the above-mentioned description, in the polarized light transmission screen 30 according to the present embodiment, when the linearly polarized light emitted from the separate-type polarized light source 11a is transmitted through the 0-degree rotation regions 32a and the 90-degree rotation regions 32b, the polarization axis of the linearly polarized light can be perpendicular to the transmission axis of the polarized light transmission screen 30 precisely over a wide range of wavelengths. Therefore, in the first polarizer 42, the highly precisely linearly polarized lights may be filtered with high precision. That is, while emitting the polarized light for the right eye efficiently to the display regions 48a for the right eye, the polarized light for the right eye may be certainly absorbed over wide wavelength range to the display regions 48b for the left eye.

In addition, even if the polarized light transmission screen 30 changes the order of the arrangement of the patterned retarder 34 and the unpatterned retarder 36, it includes the same effect as the above-mentioned example. That is, the unpatterned retarder 36 first rotates the polarization axis of the linearly polarized light emitted from the separate-type polarized light source 13a for the right eye by −45 degrees. Next, the first rotation region 35a rotates the polarization axis, which was rotated by −45 degrees by the unpatterned retarder 36, by +45 degrees. On the other hand, the second rotation region 35b rotates the polarization axis, which was rotated by 45 degrees by the unpatterned retarder 36, by −45 degrees further.

Moreover, the patterned retarder 34 and the unpatterned retarder 36 may rotate the polarization axis of the emitted linearly polarized light to the opposite direction with respect to the above-mentioned example. For example, the first rotation region 35a may rotate the polarization axis of the linearly polarized light by −45 degrees emitted from the separate-type polarized light source 10a for the right eye. In this case, the second rotation region 35b rotates the polarization axis of the linearly polarized light by +45 degrees emitted from the separate-type polarized light source 10a for the right eye. Then, the unpatterned retarder 36 further rotates the polarization axis by +45 degrees which was rotated +45 degrees by the second rotation region 35b while rotating the polarization axis by +45 degrees which was rotated −45 degrees by the first rotation region 35a. Also in this case, the same effect as the above-mentioned example is acquired.

FIG. 10 shows a process by which the polarized light transmission screen 30 shown in FIG. 9 rotates in steps the linearly polarized light projected on the observer's left eye. In this embodiment, the polarization axis of the linearly polarized light emitted from the separate-type polarized light source 10b for the left eye is the polarization axis of the linearly polarized light emitted from the separate-type polarized light source 10a for the right eye, i.e., the horizontal direction. The first rotation regions 35a rotate the polarization axis of the linearly polarized light by +45 degrees, which is emitted from the separate-type polarized light source 10b for the left eye. The second rotation regions 35b rotate the polarization axis of the linearly polarized light by −45 degrees, which is emitted from the polarization separate-type polarized light source 10a for the left eye.

The unpatterned retarders 36 rotates the linearly polarized lights, which are rotated by +45 degrees by the first rotation regions 35a and rotated by −45 degrees by the second rotation regions 35b, by −45 degrees. Consequently, the polarization axis of the linearly polarized light transmitted through the first rotation regions 35a and the unpatterned retarder 36 is perpendicular to the polarization axis of the linearly polarized light transmitted through the second rotation regions 35b and the unpatterned retarder 36. For example, in this embodiment, the polarization axis of the linearly polarized light transmitted through the first rotation regions 35a and the unpatterned retarder 36 is rotated to the horizontal direction, which is the same as the time of the incidence to the patterned retarder 34. Then, the polarization axis of the linearly polarized light, which is transmitted through the second rotation regions 35b and the unpatterned retarder 36, is rotated to the vertical direction, which is perpendicular to the direction in which the linearly polarized light enters into the patterned retarder 34.

In the polarized light transmission screen 30 according to the present embodiment, when the linearly polarized light emitted from the separate-type polarized light source 10b is transmitted through the 0-degree rotation regions 32a and 90-degree rotation regions 32b, the polarization axis of the linearly polarized light can be perpendicular to the transmission axis of the polarized light transmission screen 30 precisely over a wide range of wavelength. Therefore, in the first polarizer 42, the highly precisely orthogonal linearly polarized lights may be filtered. That is, while emitting the polarized light for the left eye efficiently to the display regions 48b for the left eye, the polarized light for the left eye may be certainly absorbed over wide wavelength range to the display regions 48s for the right eye.

As mentioned above, as is apparent from the description with reference to FIG. 9 and FIG. 10, according to the polarized light transmission screen 30 according to the present embodiment, the vertical or horizontal polarization axis of the linearly polarized light can be perpendicular to the transmission axis of the polarized light transmission screen 30 precisely over a wide range of wavelengths. Therefore, the stereoscopic image displaying apparatus 100 can separate the polarized light for the left eye and the linearly polarized light for the right eye with high precision to the left and right eyes of the observer by the highly precisely orthogonal polarized light being transmitted through the first polarizer 42 or the polarized glasses 60. Therefore, regardless of whether the glasses system or the glassless system is to be employed, the stereoscopic image displaying apparatus 100 can display a clear stereoscopic image with little cross talk by using the polarized light transmission screen 30.

In addition, the optical axis of the first rotation regions 35a may form ±22.5 degrees with respect to the polarization axis of the linearly polarized light emitted from the separate-type polarized light source 10b for the left eye. Also in this case, like the above-mentioned example, the direction of the optical axis of the second rotation regions 35b is directed so as to form ±45 degrees with respect to the optical axis of the first rotation regions 35a, and the direction of the optical axis of the unpatterned retarder 36 is made perpendicular to the optical axis of first rotation regions 35a. Then, the portion corresponding to the first rotation regions 35a of the unpatterned retarder 36 and the first rotation regions 35a constitute the 0-degree rotation regions 32a, and the portion corresponding to the second rotation regions 35b of the unpatterned retarder 36 and the second rotation regions 35b constitute the 0-degree rotation regions 32a.

As is apparent from the foregoing description, the stereoscopic image displaying apparatus 100 according to the present embodiment can display a clear stereoscopic image with little cross talk.

In addition, the relative angles between the polarization, transmission, or optical axes of any two component among the polarizer 14, the linear Fresnel lens 22a, the linear Fresnel lens 22b, the first polarizer 42, the second polarizer 44, the patterned retarder 34, the unpatterned retarder 36, and the polarized glasses 60 do not need to be strictly equal to the relative angles described in the present embodiment. The relative angle may shift from the relative angle described in the present embodiment within limits where the cross talk of the stereoscopic image which reaches the observer dose not cause the problem in the stereoscopic vision. It is apparent that such configuration also belongs to the technical scope of the present invention.

Although the present invention has been described by way of exemplary embodiment, the scope of the present invention is not limited to the foregoing embodiment. Various modifications in the foregoing embodiment may be made when the present invention defined in the appended claims is enforced. It is obvious from the definition of the appended claims that embodiments with such modifications also belong to the scope of the present invention.

1-15. (canceled)

16. A polarized light transmission screen rotating a polarization axis of a linearly polarized light, comprising:
90-degree rotation regions, each 90-degree rotation region including in piles three or more retarders, wherein each retarder rotates the polarization axis of the linearly polarized light less than 90 degrees in steps so that the 90-degree rotation region rotates the polarization axis by 90 degrees in total; and
0-degree rotation regions, each 0-degree rotation region including in piles three or more retarders, wherein each retarder rotates the polarization axis of the linearly polarized light to the both positive and negative directions by the same degree so that the 0-degree rotation transmits the linearly polarized light with the same polarization axis as a time of incidence,
wherein the 90-degree rotation region and the 0-degree rotation region are aligned alternately along a predetermined direction, and
wherein each of at least two of the retarders for each 90-degree rotation region and each of at least two of the retarders for each 0-degree region form an unpatterned retarder.

17. A stereoscopic image displaying apparatus, comprising:
a polarized light transmission screen of claim 16;
a light source;
a liquid crystal panel, which is provided between said light source and said polarized light transmission screen and faces said polarized light transmission screen, wherein said liquid crystal panel includes display regions for a left eye displaying an image for the left eye corresponding to said first rotation regions, and display regions for a right eye displaying an image for the right eye corresponding to said second rotation regions, wherein said display regions for the left eye and display regions for the right eye are aligned alternately in a vertical direction, and said liquid crystal panel emits a linearly polarized light into said polarized light transmission screen; and
a polarized glasses including:
a polarizer for a right eye that absorbs the linearly polarized light transmitted through said display regions for the left eye and said polarized light transmission screen, and transmits the linearly polarized light transmitted through said display regions for the right eye and said polarized light transmission screen; and
a polarizer for a left eye that absorbs the linearly polarized light transmitted through said display regions for the right eye and said polarized light transmission screen, and transmits the linearly polarized light transmitted through said display regions for the left eye and said polarized light transmission screen.

18. The stereoscopic image displaying apparatus as claimed in claim 17, wherein said display regions for the right eye correspond to said first rotation regions, said polarizer for the right eye includes a polarized light absorption axis perpendicular to a polarization axis of the linearly polarized light emitted from said liquid crystal panel, and said polarizer for the left eye includes a polarized light absorption axis parallel to a polarization axis of the linearly polarized light emitted from said liquid crystal panel.

19. The stereoscopic image displaying apparatus as claimed in claim 17, wherein said display regions for the left eye correspond to said first rotation regions, said polarizer for the left eye includes a polarized light absorption axis perpendicular to a polarization axis of the linearly polarized light emitted from said liquid crystal panel, and said polarizer for the right eye includes a polarized light absorption axis parallel to a polarization axis of the linearly polarized light emitted from said liquid crystal panel.
